(19) United States
(12) Patent Application Publication
(10) Pub. No.: US 2005/0253402 A1
(43) Pub. Date: Nov. 17, 2005

(54) Security device for a door

(76) Inventors: Alexander Ernest Griffin, Birmingham (GB); William Brendan John Whelan, Atherstone (GB)

Correspondence Address: Ira S Dorman, Suite 200, 330 Roberts Street, East Hartford, CT, 06108, US

(21) Appl. No.: 10/511,129

(22) PCT Filed: Apr. 16, 2003
(86) PCT No.: PCT/GB03/01626

§ 371 Date: Apr. 20, 2005

(30) Foreign Application Priority Data
Apr. 23, 2002 (GB) 0209173.4

(51) Int. Cl. E05C 17/04

(52) U.S. Cl. 292/262

(57) ABSTRACT

A security device for limiting opening of an inwardly-openable door (4) in a building. The device comprises keep means (6) adapted to be secured to a region of an inside surface (8) of the door (4) and arm means (12) adapted to be swivelably secured at a first end (14) thereof to an interior surface (16) of the building fixed relative to the door (4). The arm means (12) is adapted to be manually swivelled between a first position, clear of the door (4), and a second position in which a second end (18) of the arm means (12) abuttingly engages the keep means (6) to limit opening of the door (4). At least one spring means is provided incorporated in the keep means (6) and/or the arm means (12) to absorb energy upon engagement of the second end (18) of the arm means (12) with the keep means (6).

This invention relates to a security device for a building and which is, operable to limit opening of an inwardly-openable door in the building, particularly to prevent forced entry by an intruder while allowing sufficient opening of the door to enable identity of a person outside the door to be determined.

The present invention also provides for an alarm to be actuated when forced entry is attempted through the door.

According to the present invention there is provided a security device for limiting opening of an inwardly-openable door in a building comprising: keep means, comprising an elongate block, adapted to be secured to a region of an inside surface of the door; and arm means adapted to be swivelably secured at a first end thereof to an interior surface of the building fixed relative to the door, the arm means being adapted to be manually swivelled between a first position, clear of the door, and a second position in which a second end of the arm means abuttingly engages an outwardly open slot at a first end of the elongate block of the keep means to limit opening of the door, wherein the elongate block incorporates an axial cylindrical recess having an end open to the slot and in which is received a piston means and a first spring means, the first spring means being provided to absorb energy upon engagement of the second end of the arm means with the keep means, the piston means being adapted to be contacted, and displaced to a limited extent in the axial cylindrical recess against the first spring means, by the second end of the arm means when forceful pressure is applied to the door to attempt opening of the door.

The spring means may additionally serve to recoil and effect or assist closure of the door in event of the door being undesirably jolted inwardly from outside.

The region of the inside surface of the door to which the keep means is adapted to be secured may be adapted to be adjacent to a hinged edge of the door.

The interior surface of the building to which the arm means is adapted to be swivelably secured may be a wall of the building adjacent to a hinged edge of the door, and such as extending at substantially ninety degrees to the door when the door is closed. Intermediate support means, such as of block form, may be provided for securing to the wall and adapted to have the arm means swivelably secured thereto.

The outwardly open slot of the keep means may be of U-shape.

The elongate block may be adapted to be secured to the region of the inside surface of the door by way of a first base plate to which it is secured, and which may be apertured to receive one or more securing means, such as one or more threaded fasteners.

The piston means may have a first face provided with a recess for receiving the second end of the arm means and may have a second face, opposite the first face, provided with a protrusion for accommodating the first spring means.

The outwardly open slot at the first end region of the elongate block may have an end portion sloping inwardly towards the piston means in the axial cylindrical recess to direct the second end of the arm means into alignment with the piston means and the axial cylindrical recess.

The axial cylindrical recess may extend through the elongate block to a second end region of the elongate block opposite to the first end region of the block and may be closed by a cap means, which may be threaded into or onto the second end region of the elongate block.

The arm means, at least at the second end thereof, may be of substantially solid cylindrical form.

The first end of the arm means may be provided with a bearing component, secured thereto or integral therewith, which is rotatable in a mounting component adapted to be secured to the interior surface of the building fixed relative to the door. The bearing component may be arranged for rotation in the mounting component about a substantially vertical axis, when the mounting component is secured to the interior surface of the building, and such that the arm means is able to be swivelled between the first and second positions in a substantially horizontal plane.

The mounting component may comprise upper and lower portions journalled to rotatably receive the bearing component therebetween and secured to a second base plate which may be apertured to receive one or more securing means, such as one or more threaded fasteners.

A second spring means, for example a compression spring, may be incorporated with the arm means such that the first end of the arm means is slidably secured to the bearing component against the second spring means and with the arm means displaceable in its axial direction relative to the bearing component.

The second spring means may reinforce the function of the first spring means.

Switch means may be incorporated in the bearing component and adapted to be actuated by axial displacement of the arm means relative to the bearing component against the second spring means to operate an alarm means, such as an audible alarm means, to provide a warning that forced entry through the door is being attempted. Such alarm means may be incorporated in a cavity in the mounting component, or may be at a remote location.

One or more batteries may be incorporated in a cavity provided in the mounting component, such cavity being suitably closed by a cap means which may threadedly engage the mounting component.

The second spring means may have a spring rate which is lower than that of the first spring means, whereby the switch means is actuated before the first spring means is fully compressed.

The device may substantially comprise metal, such as brass or aluminium. When the metal is aluminium, it may be surface-anodised.

The first spring-means may be a compression spring.

For a better understanding of the present invention and to show more clearly how it may be carried into effect, reference will now be made, by way of example, to the accompanying drawings in which:

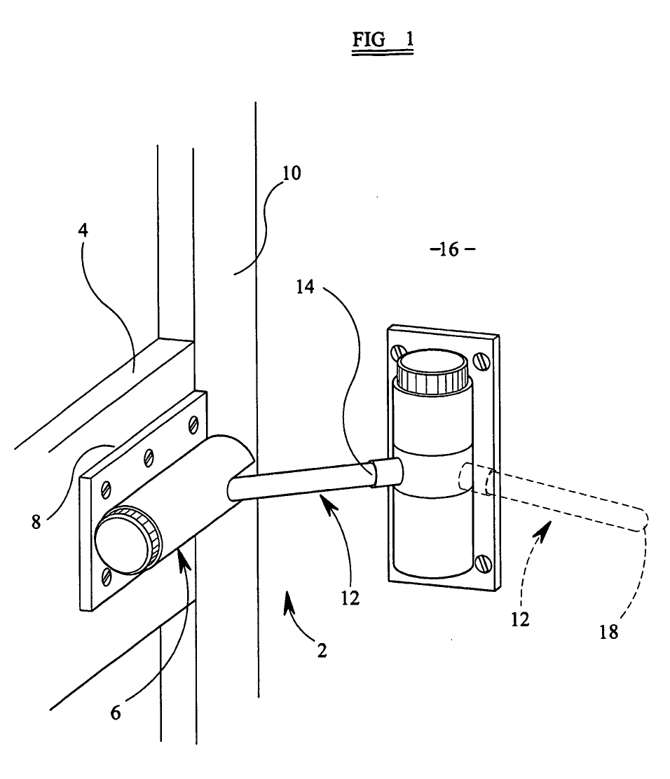

FIG. 1 is a perspective view of an embodiment of a security device according to the present invention installed in association with a door in a building;

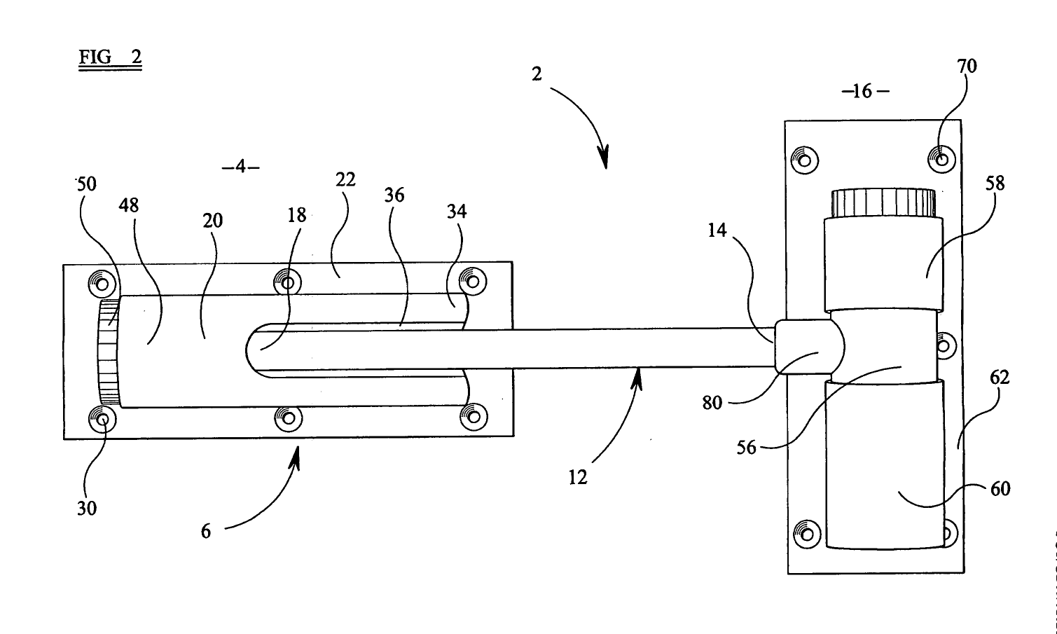

FIG. 2 is a plan view of the security device of FIG. 1;

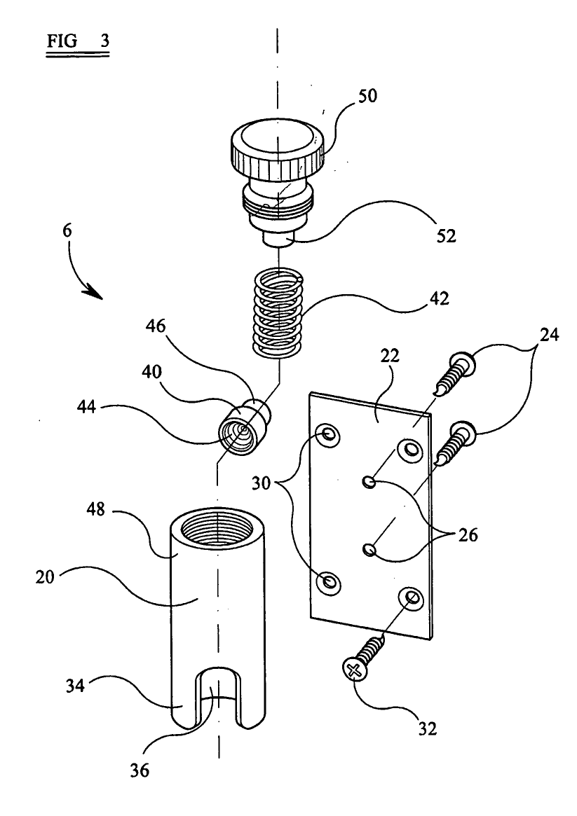

FIG. 3 is an exploded view of keep means forming part of the security device of FIGS. 1 and 2;

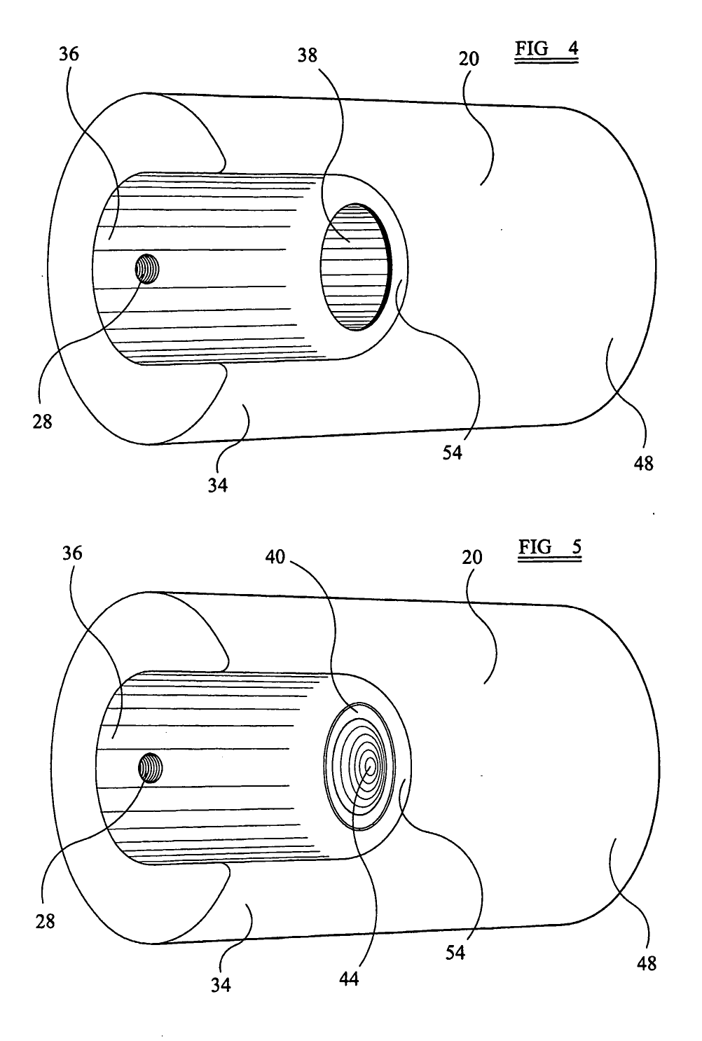

FIG. 4 is a perspective view of an elongate block in the keep means of FIG. 3;

FIG. 5 is a perspective view of the elongate block of FIG. 4, showing a piston means provided in a cylindrical recess thereof;

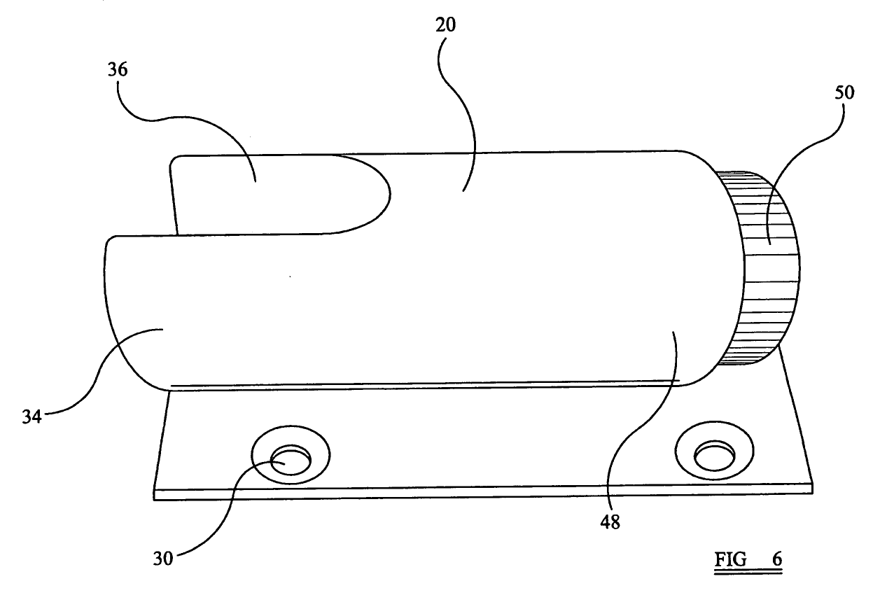

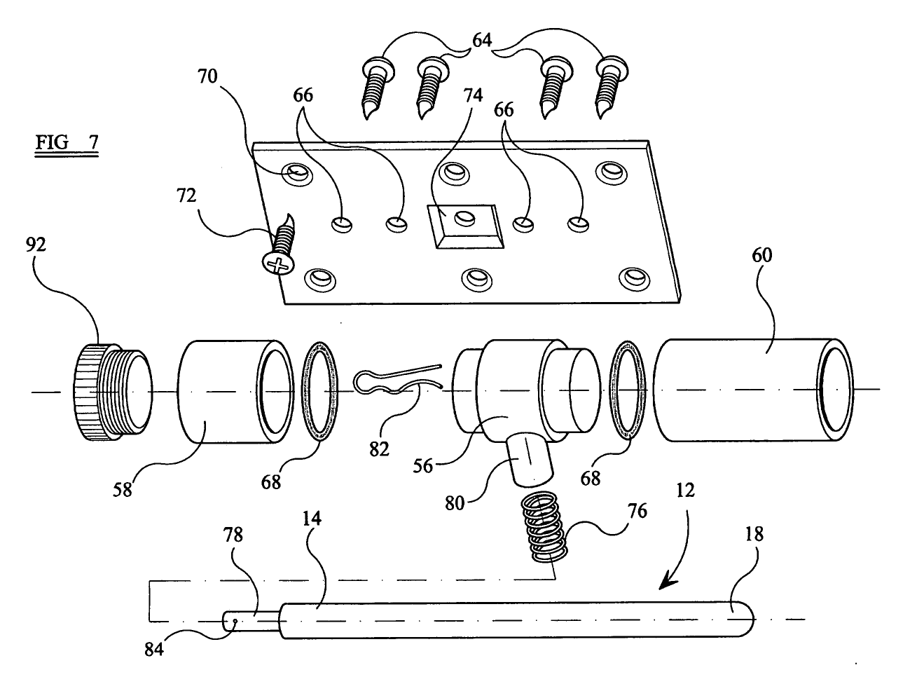

FIG. 6 is a perspective view of the elongate block of FIG. 5 secured to a base plate;

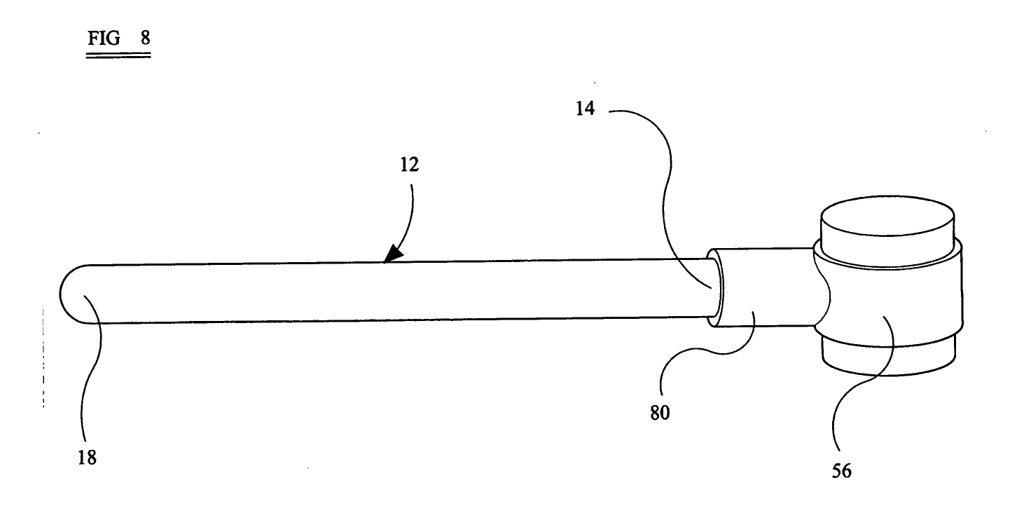

FIG. 7 is an exploded view of swivelably-mounted arm means forming part of the security device of FIGS. 1 and 2;

FIG. 8 is a perspective view of part of the arm means of FIG. 7 mounted in a bearing component; and

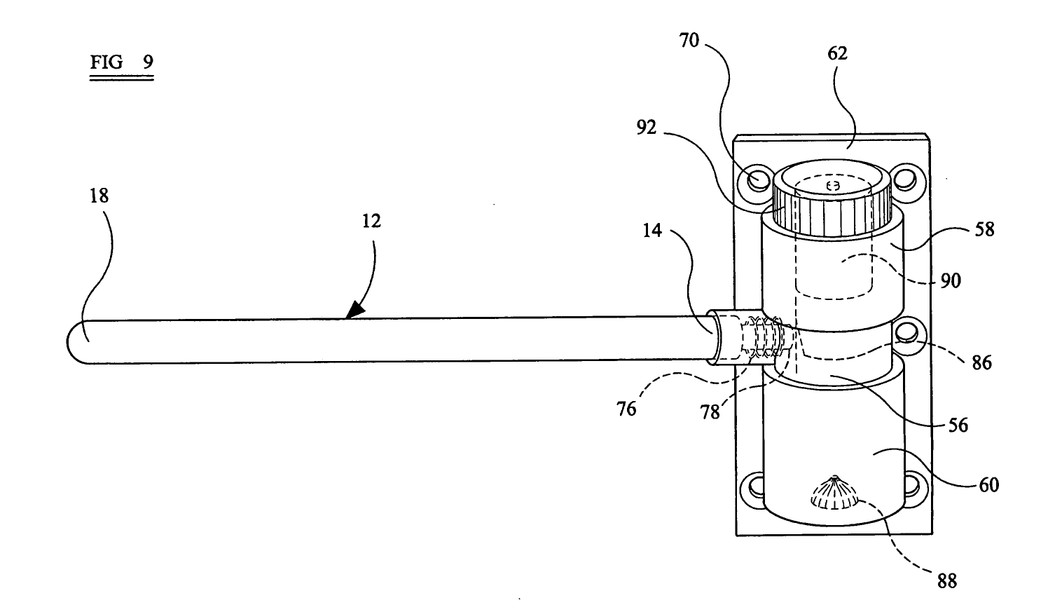

FIG. 9 is a perspective view of the assembled swivelably-mounted arm means of FIG. 7, provided with an alarm means.

Referring to FIGS. 1 and 2, a security device 2 is provided for limiting opening of an inwardly-openable door 4 in a building. The device 2 has a keep means 6 adapted to be secured to a region of an inside surface 8 of the door 4, adjacent to a hinged edge 10 of the door 4.

The device 2 also has an arm means 12 which is adapted to be swivelably secured at a first end 14 thereof to an interior surface 16 of the building fixed relative to the door 4. The interior surface 16 of the building suitably comprises an internal wall of the building adjacent to the hinged edge 10 of the door 4 and suitably extending at substantially ninety degrees to the door 4 when the door is closed.

If required, where a suitable wall extending at ninety degrees is not available, an intermediate support means (not shown), such as of block form, may be provided for securing to the wall comprising the surface 16 and adapted to have the arm means 12 swivelably secured thereto.

The arm means 12 is arranged to be manually swivelled between a first position, as shown by the dotted outline in FIG. 1, in which it is clear of the door, and a second position in which a second end 18 thereof abuttingly engages the keep means 6 to limit opening of the door 4. In the first position of the arm means 12, the door 4 is openable inwards in a normal unrestricted manner.

The arm means 12 is suitably of substantially solid cylindrical form, at least at the second end 18 thereof.

As will be described in detail hereinafter, at least one spring means is incorporated in the keep means 6, or in the keep means and the arm means 12 and operating in an axial direction of the arm means 12. Such spring means is or are arranged to absorb energy upon dynamic engagement of the second end 18 of the arm means 12 with the keep means 6 and reduces the likelihood of damage to the door 4 and its frame and hinges.

The spring means additionally serves or serve to recoil and effect or assist closure of the door 4 by effecting rebound of the door 4 in event of the door being undesirably jolted by an intruder attempting forcible entry from outside.

As will also be described in detail hereinafter, the security device 2 may be adapted to operate an alarm means when forcible entry through the door 4 is attempted.

The security device 2 of the present invention accordingly is readily arranged to allow complete freedom of opening of the door 4, when the arm means 12 is in the first position shown by the dotted outline in FIG. 1, or allow only a predetermined limited extent of opening of the door 4 when the arm means 12 is abuttingly engaged with the keep means 6. Such predetermined limited extent of opening may be sufficient to provide a gap to allow identification of a person outside the door 4 and/or to permit receipt of items, such as mail, through the gap.

The security device 2 substantially comprises metal, such as brass or aluminium. When the metal is aluminium, its surface may be anodised.

Referring additionally now to FIGS. 3 to 6, the keep means 6 comprises an elongate block 20 secured to a first base plate 22 by means of threaded fasteners 24 passing through holes 26 in the first base plate 22 and into threaded holes 28 provided in the elongate block 20. The first base plate 22 is provided with holes 30 therein through which screws 32 are passed for securing the keep means 6 to the inside surface of the door 4.

The elongate block 20 is provided, at a first end region 34 thereof, with an outwardly open U-shaped slot 36 for receiving the second end 18 of the arm means 12.

The elongate block 20 incorporates an axial cylindrical recess 38 (FIG. 4) having an end open to the U-shaped slot 36 and in which is received a piston 40 and a first compression spring 42. The piston 40 has a first face 44 provided with a recess for abuttingly receiving the second end 18 of the arm means 12 when the latter is located in the U-shaped slot 36.

The piston 40 also has a second face provided with a protrusion 46 which fits inside one end of the first compression spring 42.

The axial cylindrical recess 38 extends through the elongate block 20 to a second end region 48 of the elongate block 20 and is closed by a cap means 50 which is threaded into, but could be threaded onto, the second end region 48 of the elongate block 20. The cap means 50 is provided with a protrusion 52 for locating in the first compression spring 42.

When the arm means 12 is engaged with the U-shaped slot 36, and forceful pressure is applied to the door 4 to attempt to open the door, the second end 18 of the arm means abuttingly engages the recessed first face 44 of the piston 40 and displaces the piston 40 to a limited extent against the first compression spring 42, thus absorbing energy resulting from forcible movement of the door 4 and preventing damage to the door and its ancillaries, such as its frame and hinges.

The first compression spring 42 also recoils and has the effect of slamming shut the door 4 as an additional safety feature.

In order to assist alignment of the second end 18 of the arm means 12 with the piston 40, the outwardly open slot 36 at the first end region 34 of the elongate block 20 may have an end portion 54 sloping inwardly towards the piston 40 to direct the second end 18 of the arm means 12 towards the piston 40.

Referring now to FIGS. 7 to 9, in addition to FIG. 2, the first end 14 of the arm means 12 is provided with a bearing component 56 which is rotatable in a mounting component comprising upper and lower portions 58 and 60. The mounting component 58, 60 is secured to a second base plate 62 by means of threaded fasteners 64 passing through holes 66 in the second base plate 62. The upper and lower portions 58, 60 comprising the mounting component are suitably journalled to rotatably receive the bearing component 56 therebetween, sealing rings 68, such as of rubber or neoprene being provided at the interfaces between the bearing component 56 and the mounting component 58, 60.

The second base plate 62 is provided with holes 70 by means of which the second base plate 62 is secured by screws 72 directly or indirectly to the interior surface 16, such as an inner wall, of the building.

The second base plate 62 with its assembled components is secured to the interior surface 16 of the building such that the bearing component 56 is rotatable in the mounting component 58, 60 about a substantially vertical axis and such that the arm means 12 is able to be swivelled between its first and second positions in a substantially horizontal plane.

A recess 74 is provided in the second base plate 62 to facilitate rotation of the bearing component 56.

A second compression spring 76 is arranged on a stepped portion 78 at the first end 14 of the arm means 12 and operating such that the first end 14 of the arm means 12 is slidably secured in a sleeve portion 80 of the bearing component 56 against the second compression spring 76. With this arrangement, the arm means 12 is displaceable in its axial direction relative to the bearing component 56. A clip 82 engages a hole 84 in the stepped portion 78 at the first end 14 of the arm means 12 to retain the first end 14 of the arm means 12 in the bearing component 56.

A switch means 86 (FIG. 9) can be incorporated in the bearing component 56 and adapted to be actuated by axial displacement of the arm means 12 relative to the bearing component 56 against the second compression spring 76, to operate an alarm means 88, such as a siren or other audible alarm means, to provide a warning that forced entry through the door 4 is being attempted. Such an alarm means 88 can be incorporated in a cavity in the mounting component 58, 60, such as in the lower portion 60 of the mounting component. However, the alarm means 88 could be arranged at a remote location and/or could form part of a general security alarm system provided in the building.

One or more batteries 90 for powering the alarm means 88 can be provided inside the mounting component 58, 60, such as in a cavity in the upper portion 58 of the mounting component. Access to the battery or batteries 90 is suitably arranged by means of a cap 92 threadedly engaging the mounting component 58, 60.

The second compression spring 76 suitably has a spring rate which is lower than that of the first compression spring 42, whereby the switch 86 is actuated before the first compression spring 42 is fully compressed.

The second compression spring 76 may also reinforce the function of the first compression spring 42.

1. A security device (2) for limiting opening of an inwardly-openable door (4) in a building, comprising: keep means (6) comprising an elongate block (20), adapted to be secured to a region of an inside surface (8) of the door (4); and arm means (12) adapted to be swivelably secured at a first end (14) thereof to an interior surface (16) of the building fixed relative to the door (4), the arm means (12) being adapted to be manually swivelled between a first position, clear of the door (4), and a second position in which a second end (18) of the arm means (12) abuttingly engages an outwardly open slot (36) at a first end of the elongate block (20) of the keep means (6) to limit opening of the door (4), wherein the elongate block (20) incorporates an axial cylindrical recess (38) having an end open to the slot (36) and in which is received a piston means (40) and a first spring means, the first spring means being provided to absorb energy upon engagement of the second end (18) of the arm means (12) with the keep means (6), the piston means (40) being adapted to be contacted, and displaced to a limited extent in the axial cylindrical recess against the first spring means (42), by the second end (18) of the arm means (12) when forceful pressure is applied to the door (4) to attempt opening of the door (4).

2. A device as claimed in claim 1, wherein the spring means additionally serves to recoil and effect closure of the door (4) in event of the door (4) being undesirably jolted inwardly from outside.

3. A device as claimed in claim 1, wherein the region of the inside surface (8) of the door (4) to which the keep means (6) is adapted to be secured is adapted to be adjacent to a hinged edge (10) of the door (4).

4. A device as claimed in claim 1, wherein the interior surface (16) of the building to which the arm means (12) is adapted to be swivelably secured is a wall of the building adjacent to a hinged edge (10) of the door (4), and such as extending at substantially ninety degrees to the door (4) when the door (4) is closed.

5. A device as claimed in claim 1, wherein intermediate support means is provided for securing to the wall and adapted to have the arm means (12) swivelably secured thereto.

6. A device as claimed in claim 5, wherein the intermediate support means is of block form.

7. (canceled)

8. A device as claimed in claim 1, wherein the outwardly open slot (36) of the elongate block (20) is of U-shape.

9. A device as claimed in claim 1, wherein the elongate block (20) is adapted to be secured to the region of the inside surface (8) of the door (4) by way of a first base plate (12) to which it is secured.

10. A device as claimed in claim 9, wherein the first base plate (12) is apertured to receive at least one securing means (24).

11. A device as claimed in claim 10, wherein the at least one securing means is a threaded fastener (24).

12. (canceled)

13. A device as claimed in claim 1, wherein the piston means (40) of the elongate block (20) has a first face (44) provided with a recess for receiving the second end (18) of the arm means (12).

14. A device as claimed in claim 13, wherein the piston means (40) has a second face, opposite the first face (44), provided with a protrusion for accommodating the first spring means (42).

15. A device as claimed in claim 1, wherein the outwardly open slot at the first end region of the elongate block (20) has an end portion (54) sloping inwardly towards the piston means (40) in the axial cylindrical recess to direct the second end (18) of the arm means (12) into alignment with the piston means (40) and the axial cylindrical recess.

16. A device as claimed in claim 1, wherein the axial cylindrical recess (38) extends through the elongate block (20) to a second end region (48) of the elongate block (20) opposite to the first end region of the block.

17. A device as claimed in claim 1, wherein the axial cylindrical recess (38) is closed by a cap means (50).

18. A device as claimed in claim 17, wherein the cap means (50) is threaded into the second end region of the elongate block (20).

19. A device as claimed in claim 17, wherein the cap means is threaded onto the second end region of the elongate block (20).

20. A device as claimed in that claim 1, wherein the arm means (12), at least at the second end (18) thereof, is of substantially solid cylindrical form.

21. A device as claimed in claim 1 wherein the first end (14) of the arm means (12) is provided with a bearing component (56), selected from being secured thereto and integral therewith, which is rotatable in a mounting component adapted to be secured to the interior surface (16) of the building fixed relative to the door (4).

22. A device as claimed in claim 21, wherein the bearing component (56) is arranged for rotation in the mounting component about a substantially vertical axis, when the mounting component is secured to the interior surface (16) of the building, and such that the arm means (12) is able to be swivelled between the first and second positions in a substantially horizontal plane.

23. A device as claimed in claim 21, wherein the mounting component comprises upper (58) and lower (60) portions journalled to rotatably receive the bearing component (56) therebetween and secured to a second base plate (62) which is apertured to receive at least one securing means (64).

24. A device as claimed in claim 23, wherein the securing means comprises threaded fasteners (64).

25. A device as claimed in claim 21, wherein a second spring means (76) is incorporated with the arm means (12) such that the first end (14) of the arm means (12) is slidably secured to the bearing component (56) against the second spring means (76) and with the arm means (12) displaceable in its axial direction relative to the bearing component (56).

26. A device as claimed in claim 25, wherein the second spring means (76) reinforces the function of the first spring means (42).

27. (canceled)

28. A device as claimed in claim 25, wherein switch means (86) is incorporated in the bearing component (56) and adapted to be actuated by axial displacement of the arm means (12) relative to the bearing component (56) against the second spring means (76) to operate an alarm means (88) to provide a warning that forced entry through the door (4) is being attempted.

29. A device as claimed in claim 28, wherein the alarm means (88) is an audible alarm means.

30. A device as claimed in claim 28 wherein the alarm means is incorporated in a cavity in the mounting component.

31. A device as claimed in claim 28 wherein the alarm means is at a remote location.

32. A device as claimed in (90) are claim 21, wherein at least one battery (90) is incorporated in a cavity provided in the mounting component.

33. A device as claimed in claim 32, wherein the cavity is suitably closed by a cap means which threadedly engages the mounting component.

34. A device as claimed in claim 28, wherein the second spring means (76) has a spring rate which is lower than that of the first spring means (42), whereby the switch means (86) is actuated before the first spring means (42) is fully compressed.

35. A device as claimed in claim 1 wherein the device substantially comprises metal.

36. A device as claimed in claim 35, wherein the metal is selected from brass and aluminium.

37. A device as claimed in claim 36, wherein the aluminium is surface-anodised.

38. A device as claimed in claim 1, wherein the first spring means additionally serves to recoil and assist closure of the door (4) in event of the door (4) being undesirably jolted inwardly from outside.

39. A device as claimed in claim 1, wherein the first spring means is a compression spring.

40. A device as claimed in claim 25, wherein the second spring means is a compression spring.
